(19) United States
(12) Patent Application Publication
(10) Pub. No.: US 2008/0189151 A1
(43) Pub. Date: Aug. 7, 2008

(54) Use of force audit and compliance

(76) Inventor: Sam Rosenfeld, Beverly Hills, CA (US)

Correspondence Address: STETINA BRUNDA GARRED & BRUCKER, 75 ENTERPRISE, SUITE 250, ALISO VIEJO, CA, 92656, US

(21) Appl. No.: 11/880,712

(22) Filed: Jul. 24, 2007

Related U.S. Application Data
(60) Provisional application No. 60/834,095, filed on Jul. 27, 2006.

(51) Int. Cl. G06Q 10/00; G06F 17/30

(52) U.S. Cl. 705/7; 707/100; 707/E17.044

(57) ABSTRACT

The provision of force, the ability to cause injury or death, is subject to oversight, both internal and external. Such oversight provides assurance to authorities, clients and shareholders that the application of forces is not abused, but rather is conserved. An independent audit function will provide that assurance, and can be provided either as part of a wider audit or as a bespoke service.

### CROSS-REFERENCE TO RELATED APPLICATIONS

This patent application claims priority to provisional patent application Ser. No. 60/834,095, entitled FORCE PROTECTION AUDIT AND COMPLIANCE, filed on Jul. 27, 2006.

### STATEMENT RE: FEDERALLY SPONSORED RESEARCH/DEVELOPMENT

Not Applicable

### BACKGROUND

Force is routinely used by private and public organizations. The police, military, government agencies, private military companies and security companies all have a routine requirement to use force. However, the standards required of the various organizations differ greatly, regardless of the geographical location.

In this regard, the use of force is a significant activity, one that is not only contentious but has massive implications for those upon whom force is used. The great differences in standards can lead to abuses of the power to use force.

There has been substantial commentary over the years about the use of force, and the standards applied to when that force has been used. Historically the review of the use of force by governmental organizations has taken place within those organizations or, after the fact, by the courts. There has been little anticipatory oversight of the organizations allowed to use force.

Recently it has become clear that many private organizations using force in the same environments as the US military, such as in Iraq, are using force with far less oversight than that accorded to the US military, even though the use of force by either private or public organizations in that environment will have the same detrimental effect for the US military and the wider US mission overseas. The use of force can gravely affect the tactical, operational and strategic situation for law enforcement, the military or those acting along side the military, such as private military companies. The political ramifications, at local through international level, may be significant, and therefore there must be the ability to assess the policies and activities surrounding the use of force by any potential user.

The use of lethal force has become much more prevalent since September 11, not only overseas, but also in environments such as New Orleans after Hurricane Katrina where private contractors were deployed with lethal force to control looting.

In most industries there is a clear audit trail for the manner in which operations are being carried out. The quality of vehicles being manufactured, as it relates to safety, is audited by federal authorities. The accounting support one receives is audited by the IRS. At present there is no audit provision to the security industry; such support would provide potential clients an idea of the quality of the firm they were contracting, and assurance to the government that the security companies acting in support of national interests furthered those interests not only at the strategic, but also at the tactical, level.

### BRIEF SUMMARY

This patent provides for an audit capability of the use of force, to audit both private, and if required, governmental, use of force and force provision. Force audits can not only provide assurance about practices and capabilities, but an audit after the use of force can provide reassurance to employers, clients or the government that the practitioner is using force in a manner that is responsible, legal, ethical and, where appropriate, conforms to the wider policy intent relative to the environment within which force was used.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram depicting the various elements of an audit structure related to the provision and use of force.

### DETAILED DESCRIPTION

The above description is given by way of example, and not limitation. Given the above disclosure, one skilled in the art could devise variations that are within the scope and spirit of the invention disclosed herein, including various ways of taking various factors in consideration in order to conduct a force audit. Further, the various features of the embodiments disclosed herein can be used alone, or in varying combinations with each other and are not intended to be limited to the specific combination described herein. Thus, the scope of the claims is not to be limited by the illustrated embodiments.

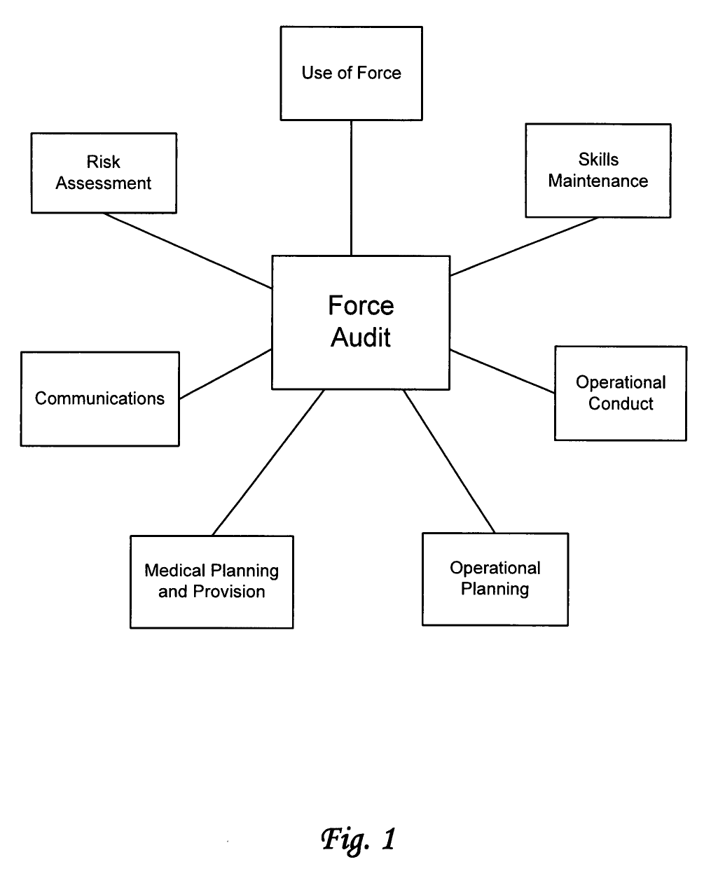

Referring now to FIG. 1, there is shown the various elements or categories upon which an audit structure is based to audit the provision and use of force. In this regard, various elements or categories are operative to determine and/or decide whether the particular application of force has not or will not be abused. Moreover, such elements and categories are operative to determine and/or predict whether the application of force either has or will be conserved. To that end, the audit structure will, at a minimum, take into consideration the following:
a. Use of Force. That prior planning and briefing take place about the use of force, that the use of standards and Rules of Engagement are policed, there is accountability and after-action reviews take place and implement recommendations.
b. Risk Assessment Processes. That risks are identified, assessed and mitigated against using a coherent process and structure.
c. Communications. That there is the provision of sufficient, robust communications to support the mission.
d. Medical Planning and Provision. That there is appropriate medical equipment, logistics and planning.
e. Operational Planning. The use of a formal planning process that identifies and classifies threats and is mindful of both resources and limitations.
f. Operational Conduct. The exercise of appropriate skills and judgement.
g. Training. Ensure that those who may use force are trained in the use of all equipment, rules of engagement and associated skills and knowledge to use force appropriately. Ensure that the training is standards, rather than time spent, based. Ensure that skill levels are maintained, and effective
h. Command Structure: That there is an appropriate, robust command structure to manage the use of force and to take appropriate action against those who misuse force.
i. Rules of Engagement. That there are clear, realistic and workable rules under which those who are able to use force are entitled under the law and operational policy do so.
j. Independent Reporting. That there is a means for those who witness the inappropriate use of force to report it, outside the immediate chain of command.
k. Equipment and Equipment Support. All equipment involved in the use of force must be appropriate to the task, and compatible with the doctrine, policies, tactics, techniques and procedures. The equipment must be maintained correctly, appropriate to its stated role and supported with spares, maintenance and maintenance skill levels to ensure that it is effective when required.
l. Policy. That there is a clear use of force policy in place, which is expressed to those likely to use force in a set of Rules of Engagement.
m. People. That there is policy and a legal framework in place that clearly states the obligations and rights of those who use force. That there is an educational process in place that states to the users of force their status, their protection under the law and the laws, policies and their rights under those laws.
n. Effect. An assessment of how the use of force policies are affecting the mission(s) of the using organization, and their effect on the wider context. This assessment may include, but is not exclusive to, political, economic and media effects.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

As discussed above, such audit, which can be referred to as a force audit, assists in the assessment of the use of force to provide assurance about specific practices and capabilities. In addition, such audit can be used to assess responsibility of the application of force, as well as whether the application of such force is consistent with policy, ethics and any other applicable laws and regulations.

What is claimed:

1. An audit structure for providing the assessment and evaluation of the provision and use of force.

2. The audit structure of claim 1 wherein said structure is based upon the following categories;
a. Use of Force;
b. Risk Assessment Processes;
c. Communications;
d. Medical Planning and Provision;
e. Operational Planning;
f. Operational Conduct;
g. Training;
h. Command Structure.
i. Policy;
j. Rules of Engagement;
k. Equipment and Equipment Support;
l. Independent Reporting;
m. People; and
n. Effect.

3. That audit can be provided to commercial, not for profit, government or any other organization.
